(19) United States
(12) Patent Application Publication
(10) Pub. No.: US 2007/0124283 A1
(43) Pub. Date: May 31, 2007

(54) Search engine with community feedback system

(76) Inventors: John Wr. Gotts, White Salmon, WA (US); John Wm. Gotts, Lewiston, ID (US)

Correspondence Address: STOEL RIVES LLP - SLC, 201 SOUTH MAIN STREET, ONE UTAH CENTER, SALT LAKE CITY, UT, 84111, US

(21) Appl. No.: 11/287,695

(22) Filed: Nov. 28, 2005

(51) Int. Cl. G06F 7/00

(52) U.S. Cl. 707/3

(57) ABSTRACT

A system for enhancing a search results page with community feedback includes a web server to receive a query from a verified user and to submit the query to a search engine for identification of one or more indexed web pages that match the query. In one embodiment, the web server includes a search results formatter to list at least a subset of the matching web pages in a random order and to display community feedback for at least one of the listed web pages based on individual feedback provided by one or more previous users. The community feedback may include a community rating as well as one or more comments by individual users.

### TECHNICAL FIELD

This application relates generally to the field of search engines and, more specifically, to Internet search engines.

### BRIEF DESCRIPTION OF THE DRAWINGS

The embodiments disclosed herein will become more fully apparent from the following description and appended claims, taken in conjunction with the accompanying drawings, in which:

FIGS. 1 and 2 are examples of search results pages enhanced with community feedback;

FIG. 3 is an exemplary comments page;

FIG. 4 is an example of a search results page including a mechanism for receiving individual feedback;

FIG. 5 is an exemplary web page with a feedback section;

FIG. 6 is an example of a separate feedback page;

FIG. 7 is a block diagram of a system for enhancing search results pages with community feedback;

FIG. 8 is a flow chart of a method for displaying community feedback; and

FIG. 9 is a data flow diagram of a process for modifying web page indexing based on community feedback.

### DETAILED DESCRIPTION

Reference is now made to the Figures in which, for the purpose of clarity, the first digit of a reference numeral indicates the figure number in which the corresponding element is first used. While the various aspects of the embodiments disclosed are presented in drawings, the drawings are not necessarily drawn to scale.

In the following description, numerous specific details of programming, software modules, user selections, network transactions, database queries, database structures, etc., are provided for a thorough understanding of various embodiments of the systems and methods disclosed herein. However, those skilled in the art will recognize that the systems and methods disclosed can be practiced without one or more of the specific details, or with other methods, components, materials, etc.

In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the Figures herein could be arranged and designed in a wide variety of different configurations.

The order of the steps or actions of the methods described in connection with the embodiments disclosed may be changed as would be apparent to those skilled in the art. Thus, any order in the Figures or Detailed Description is for illustrative purposes only and is not meant to imply a required order.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

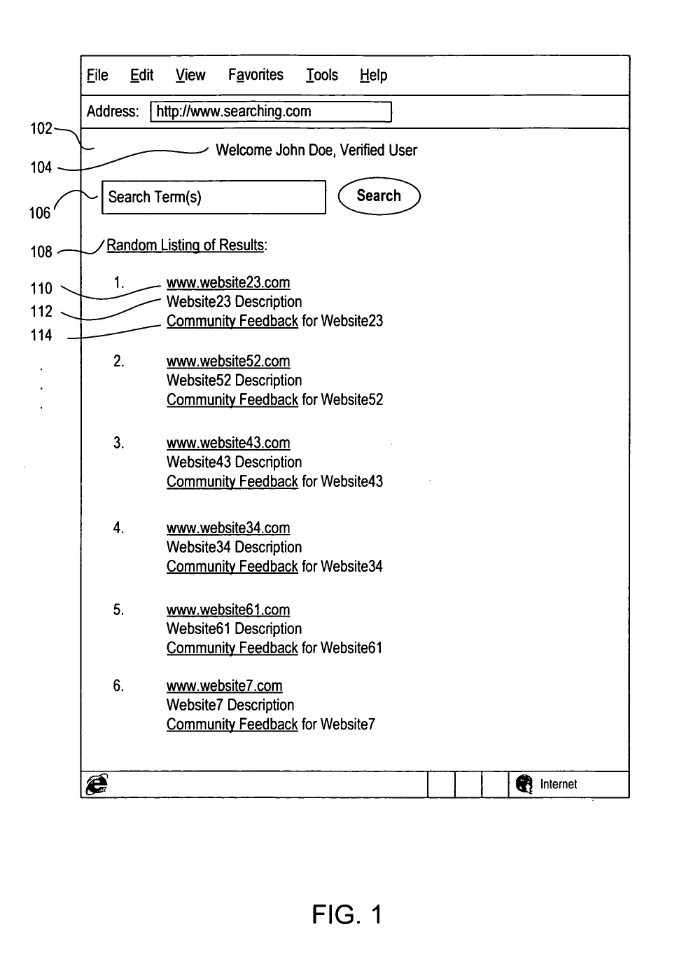

FIG. 1 is an exemplary search results page 102, which may be generated by a search engine in response to a user query. In one embodiment, the search results page 102 is displayed in a typical web browser, such as Internet Explorer®, although other types of client programs may access a search engine to receive and display a search results page 102.

As illustrated, the search results page 102 may identify a particular user 104 and may further indicate that the user has been “verified.” As explained in greater detail below, verifying a user's identity prior to submission of a query helps to prevent malicious behavior and may be used to incentivize users to leave helpful feedback. Verification may be accomplished through a variety of means, such as requiring a registration fee to be paid with a credit card, etc.

In one embodiment, after a user 104 has been verified, he or she may submit a query including one or more search terms 106 to the search engine. The search terms 106 may be accompanied by Boolean connectors, fields, and/or other operators or delimiters, the precise configuration of which is not crucial to the present discussion.

The search engine then generates (or causes to be generated) the search results page 102, which may include a list 108 of web pages 110 (or “websites” or “web documents”) that match the search terms 106 or otherwise satisfy the query. As used herein, the terms “match” or “satisfy” should be broadly interpreted. For example, a “matching” web page 110 need not include each and every one of the search terms 106 in one embodiment. Search engines often match queries against meta-data supplied by an owner of the web page 110 to facilitate indexing. Moreover, certain queries may only require that one of the search terms 106 may be found in the web page 110 (or meta-data), e.g., search terms 106 connected by an “OR” operator.

In one embodiment, the web pages 110 in the search results page 102 are listed in random order. In other words, the list 108 is not ordered, for example, according to the number of times a user “clicks” on one of the web pages 110, or the number in-bound links to a particular web page 110. As used herein, the phrase “random order” may mean a pseudorandom order as determined by a computer using a pseudorandom number generator.

As described more fully below, displaying a list 108 of web pages 110 in random order enables a larger proportion of web pages 110 to be presented to verified users 104 and thereby receive feedback. Conventionally, the top spots in search results lists are dominated by large companies who can pay for the privilege, as well as unscrupulous individuals who can defeat ranking mechanisms by robots, false links, and the like. Web pages near the top of these lists tend to remain on top due to the high traffic they almost inevitably produce.

As illustrated, each web page 110 in the list 108 may be accompanied by a description 112, which may be similar to the descriptions provided by any conventional search engine, such as Google®. For example, the description 112 may include text from the web page 110 and/or meta-data provided by the author of the web page 110.

In addition, each listed web page 110 may include community feedback 114. As described more fully below, the community feedback 114 for a web page 110 may include, for example, a community rating derived from individual ratings provided by a community of verified users 104 who have had the opportunity to view the web page 110. Alternatively, or in addition, the community feedback 114 may include one or more comments by individual verified users 104.

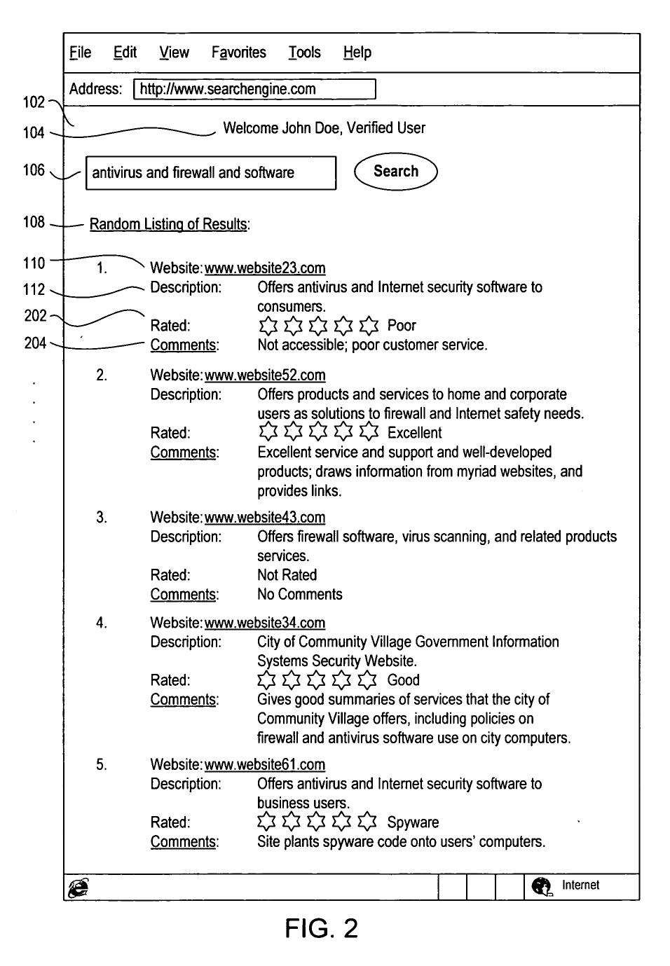

In one embodiment, as shown in FIG. 1, the community feedback 114 may be represented in the search results page 102 by a link to the actual community feedback 114. Alternatively, as shown in FIG. 2, the community feedback 114 may be displayed in whole or in part with a corresponding web page 110.

Referring to FIG. 2, the community feedback 114 for a web page 110 may be embodied as a community rating 202, e.g., poor, average, good, excellent, virus, spyware, or adware. The community rating 202 may represent an average of the individual ratings provided by a number of verified users 104. Alternatively, or in addition, a graphical representation of the community rating 202 may be provided, e.g., a number of stars or other icons. In yet another embodiment, a numerical score (e.g., 85%) may be used.

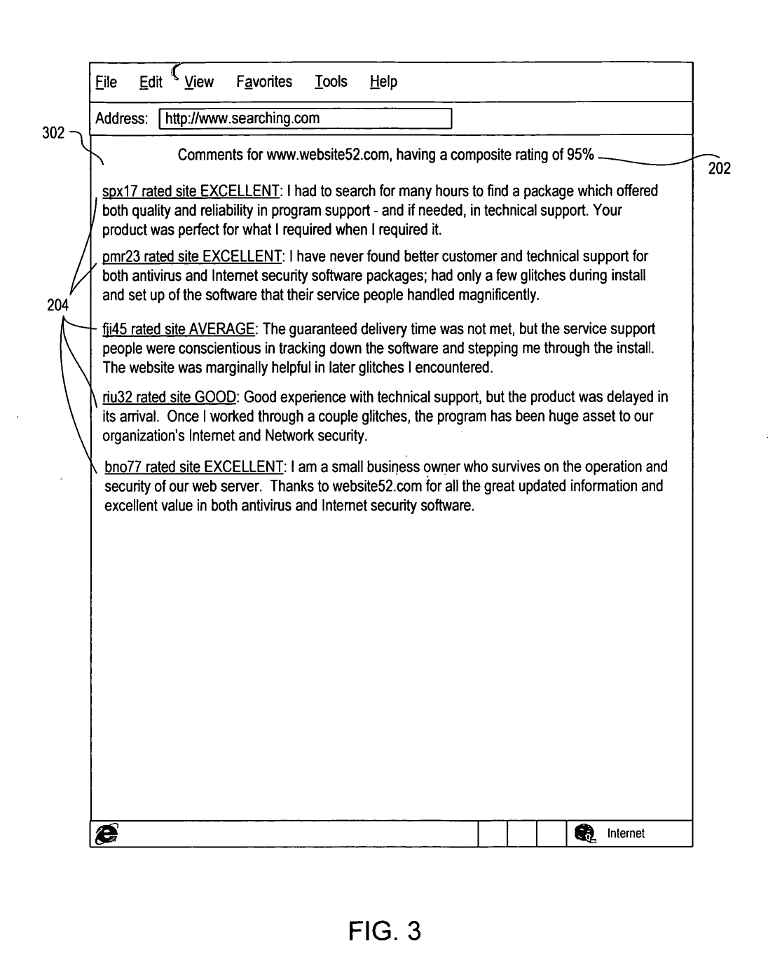

Alternatively, or in addition, community comments 204 taken from comments of individual verified users 104 may be displayed for a web page 110. In one configuration, the most recently entered comment is displayed. Alternatively, one or more randomly-selected comments may be presented. As noted above, a link may be included to allow a user to view additional commentary, such as provided in a separate comments page 302, as shown in FIG. 3. Individual comments in the comments page 302 may be sorted by date, by rating, or in other predefined or user-selected ways.

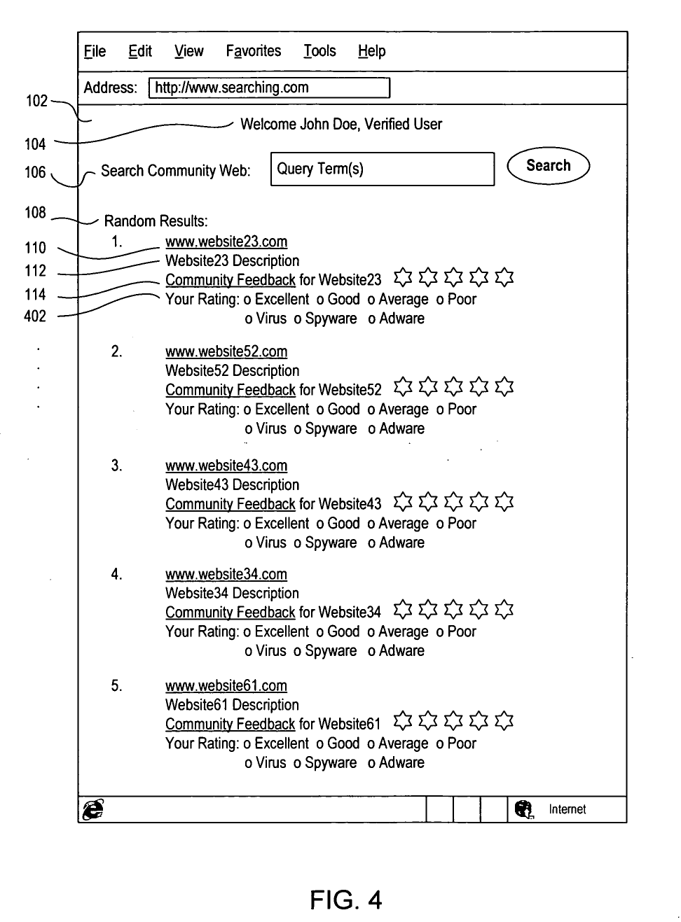

As shown in FIG. 4, one or more of the listed web pages 110 may not include community feedback 114 where none has been provided. In such cases, various methods for persuading verified users 104 to leave individual feedback may be implemented, as discussed below.

A verified user 104 may be allowed to provide individual feedback in a number of ways. For example, as shown in FIG. 4, the search results page 102 may include a feedback mechanism 402 for each listed web page 110 for inputting individual feedback. As illustrated, the feedback mechanism 402 may be embodied as a set of selectable “radio” buttons to allow a user to rate a web page 110 by selecting a button corresponding to a particular rating level, e.g., excellent, good, average, poor, virus, spyware, adware, etc. A variety of other feedback mechanisms 402 may be provided, such as check boxes, sliders, drop-down menus, text fields, or the like.

In one embodiment, when a user selects one of the listed web page 110 in FIG. 2, the search results page 102 stays open while the selected web page 110 is displayed in a new window. Thus, after viewing the selected web page 110, the user is able to return to the search results page 102 to provide individual feedback.

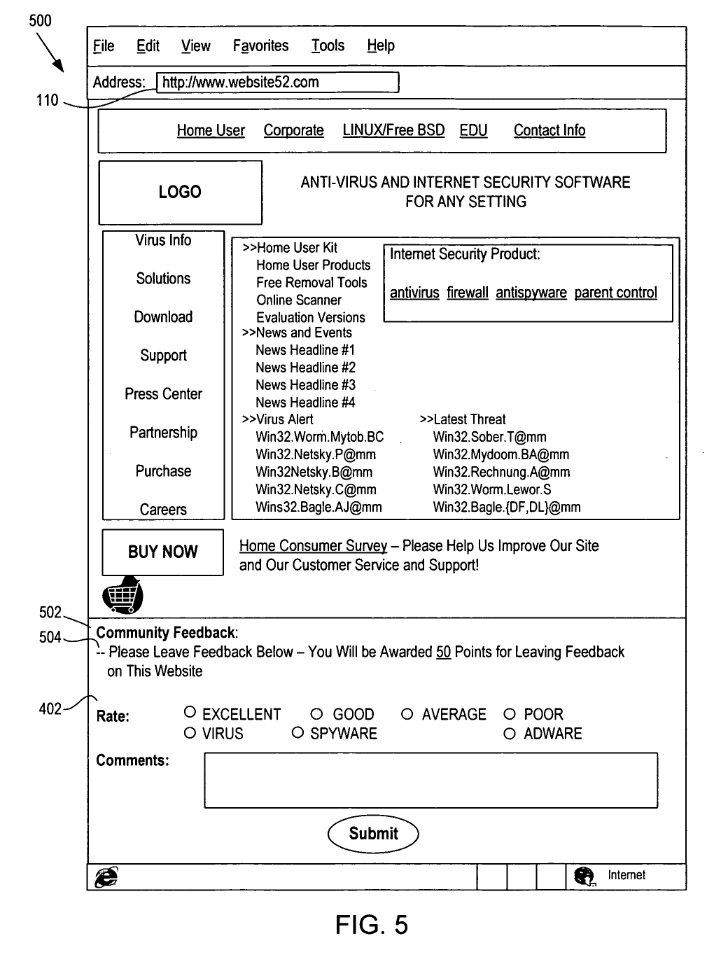

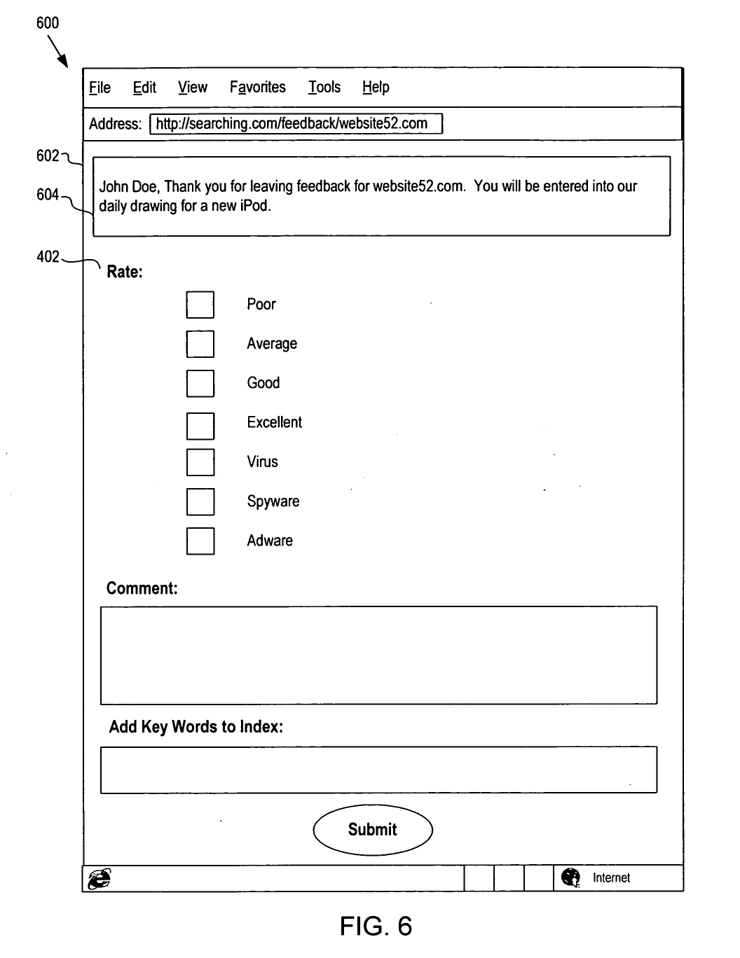

In another embodiment, as shown in FIG. 5, the feedback mechanism 402 may be displayed in a special feedback section 502 of the selected web page 110. This may be accomplished using framing or other suitable techniques. In yet another embodiment, as shown in FIG. 6, a separate feedback window 602 may be provided. The separate feedback window 602 may be embodied as a “pop-up” window displayed when a user selects a web page 1 10 from the list 108.

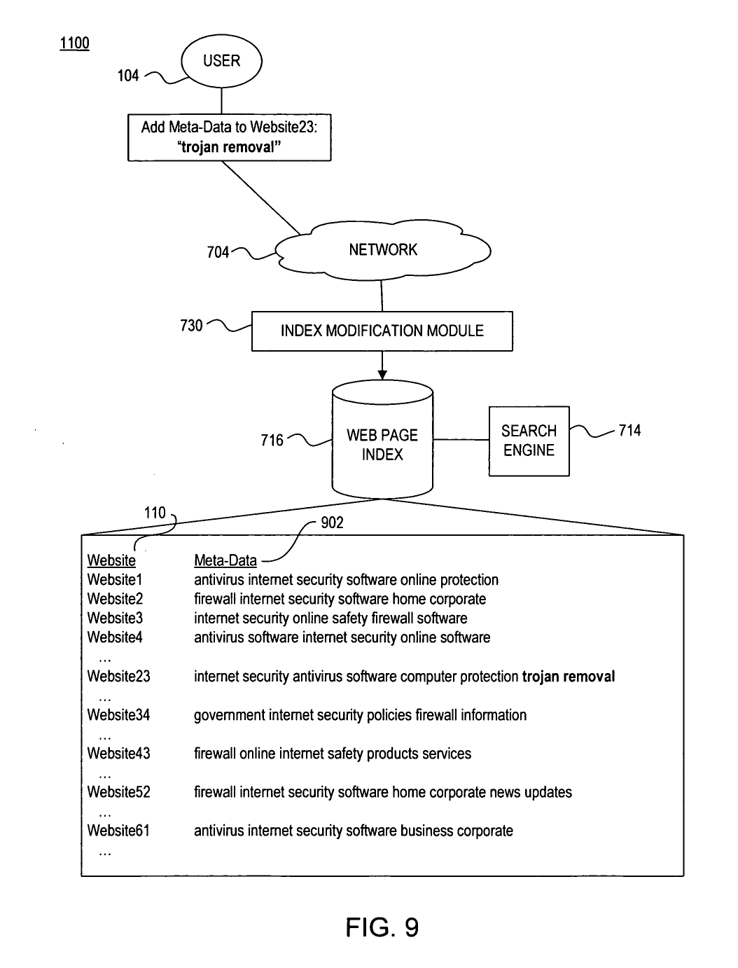

In addition to allowing the user 104 to specify individual ratings or comments, the feedback window 602 of FIG. 6 may be used to enter meta-data or key words, which may be used to change the indexing of the web page 110 to affect future searches. This process is described in greater detail below with respect to FIG. 9.

As previously noted, the user 104 may need to be persuaded to provide feedback, particularly where no feedback for a web page 110 currently exists. For example, as shown in FIG. 5, a message 504 may indicate that the user 104 will be awarded 50 “points” for leaving feedback for a web page 110. The points may be accumulated, in one embodiment, and used to purchase goods or services. Likewise, as shown in FIG. 6, a message 604 may indicate that the user 104 will be entered into a drawing for valuable items or services. In such a manner, users 104 will have an incentive to not only look at web pages 110 for which community feedback 114 has already been received, increasing the chance that community feedback 114 will be accumulated for more web pages 110.

In certain embodiments, such incentives may only be provided in the case of web pages 110 for which no community feedback 114 exists. Alternatively, the type or magnitude of the incentive may vary depending on whether the community feedback 114 has been previously provided. For example, the user 104 may receive 50 points for providing feedback on an unrated web page 110, whereas the user would receive only 10 points for providing feedback on a rated web page 110. In certain embodiments, the user 104 may be rewarded for providing new or updated feedback on web pages 110 for which the community feedback 114 is outdated.

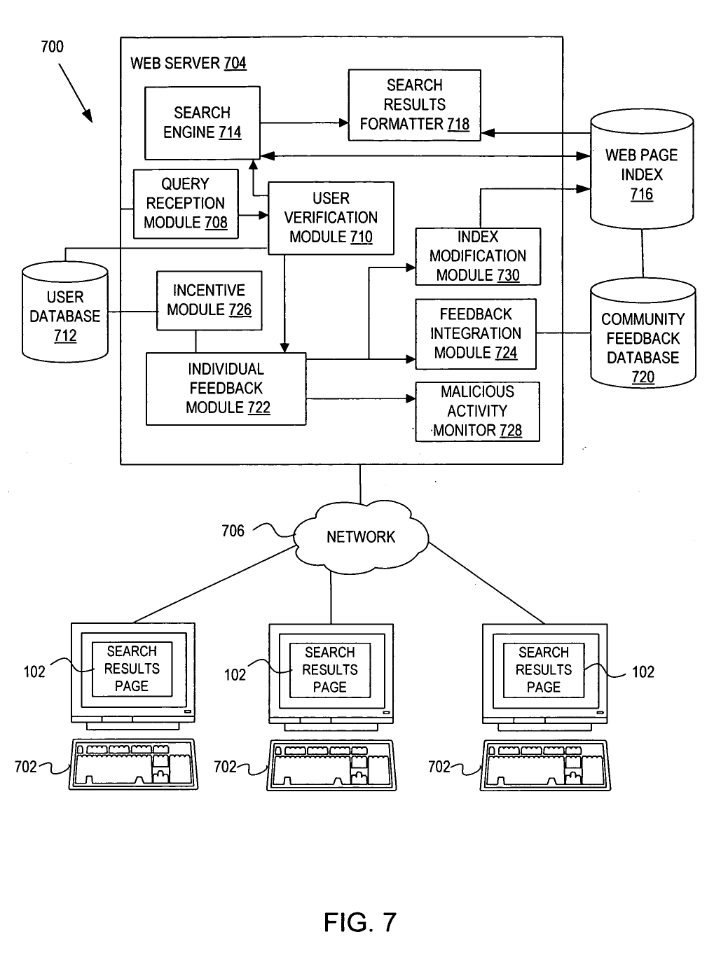

FIG. 7 is a block diagram of a system 700 for enhancing a search results page 102 with community feedback 114. One or more terminals 702 (PCs or other network-enabled devices) may access a web server 704 via a network 706, such as the Internet. The web server 704 may include or be associated with a query reception module 708 for receiving a query from one of the terminals 702. Throughout the following description, the described modules, engines, databases, and the like, may either be included within or accessible to the web server 704, and may be implemented using any suitable combination of hardware, software, and/or firmware. For example, certain modules may be implemented as server-side scripts in an Active Server Page (ASP) architecture.

A user verification module 710 may verify the user's identity before processing the query. This may be accomplished, for example, by charging a small payment to the user's credit card or by other suitable techniques. Once the user 104 has been verified, a record of the user 104 may be stored in a user database 712. The user 104 may be subsequently identified by providing, for example, a user name and password.

The user's query may then be processed by a search engine 714, which searches a web page index 716 for web pages 110 matching or otherwise satisfying the query. Techniques for searching an index 716 are known in the art and will vary depending on the particular type of search engine 714 being used.

In one embodiment, the search engine 714 produces a set of search results, which are received by a search results formatter 718. As described above, the search results formatter 718 produces a search results page 102 including a list 108 of one or more web pages 110, which is returned to the requesting terminal 702 for display. As previously noted, the web pages 110 may be listed in random order.

As explained with reference to FIGS. 1-6, the search results formatter 718 may include community feedback 114, such as a community rating 202 or comments 204, for one or more of the listed web pages 110. The community feedback 114 may be retrieved from a community feedback database 720. In alternative embodiments, however, the community feedback 114 may be integrated directly into the web page index 716. Those of skill in the art will recognize that the user database 712, web page index 716, and community feedback database 720 may all be implemented within the same database in one embodiment.

An individual feedback module 722 may display, either on or in connection with the search results page 102, a feedback mechanism 402 to allow a verified user 104 to provide individual feedback on a selected web page 110. As illustrated in FIG. 4, a feedback mechanism 402 may be included with each listed web page 110 in the search results page 102. Alternatively, as shown in FIG. 5, a displayed web page 110 may include a separate feedback section 502, which may be accomplished, for example, by the use of framing. In yet another embodiment, feedback may obtained via a separate “pop-up” feedback window 602.

Whatever feedback mechanism is used, a feedback integration module 724 receives the individual feedback provided by the verified user 104 and integrates it into the community feedback 114. As described in greater detail below, this may include adding the user's comments to the community comments 204, as well as integrating the user's rating into the community rating 202.

An incentive module 726 may provide incentives in the form of awarding points, entering the user 104 into a drawing, etc., whenever the user 104 provides individual feedback for a web page 110. In certain situations, incentives will only be provided in the case of a web page 110 for which no community feedback 114 exists, or where the community feedback 114 is stale (e.g., more than a year old). The incentive module may store an indication of any awarded points, gifts, etc., in the user database 712.

A malicious activity monitor 728 may monitor user feedback for specific ratings levels, such as virus, spyware, or adware. These levels indicate potentially harmful sites and warn users 104 to avoid those sites. In one embodiment, when the malicious activity monitor 728 detects such a rating, it may notify a system operator. In certain embodiments, where the consensus of community feedback 114 indicates that a particular web page 110 is malicious, either by harboring viruses, spyware, adware, or the like, the web page 110 may be automatically tagged for removal from the web page index 716 unless a system operator intervenes.

As described more fully with respect to FIG. 9, an index modification module 730 may allow a verified user 104 to add or even change meta-data associated with an indexed web page 110. For example, as shown in FIG. 6, a user's feedback may include certain meta-data, such as one or more key words, which may be added to the web page index 716 to assist other users 104 in finding the web page 110 by entering those key words.

If a user 104 vandalizes the web page index 716 by entering irrelevant or misleading meta-data, that user 104 may be removed from the user database 712 and banned from further participation in the community. This may also be true for a user 104 who leaves libelous feedback. Moreover, all of the offending user's feedback, including ratings, comments, and meta-data, etc., may be immediately removed by a system operator in one embodiment.

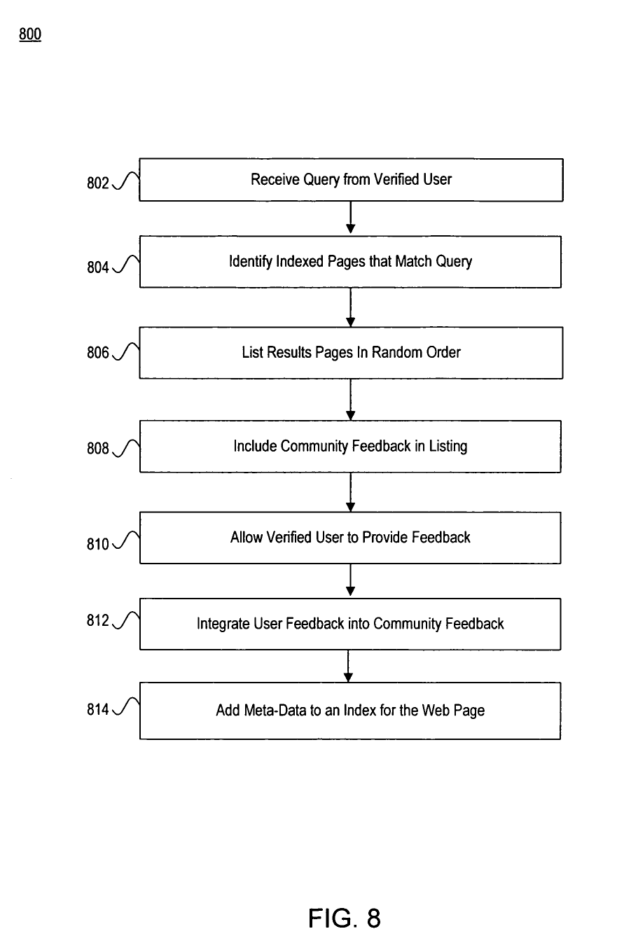

FIG. 8 is a flow chart of a method 800 for enhancing a search results page 102 with community feedback 114. In one embodiment, the method 800 may begin by receiving 802 a query from a verified user 104. The method 800 continues by identifying 804 indexed web pages 110 that match the query, and then lists 806 the matching web pages 110 pages in a random order. Community feedback 114 may be included 808 for each web page 110 for which community feedback 114 is available.

In one embodiment, a verified user 104 may be allowed 810 to provide individual feedback, after which the individual feedback is integrated 812 into the community feedback 114. In certain embodiments, the method 800 may also include adding 814 key words or other types of meta-data to an index based on the feedback, which may affect subsequent searches. This process is described in greater detail in FIG. 9.

FIG. 9 is a data flow diagram of a process for modifying web page indexing based on community feedback 114. As noted above, a web page index 716 may store meta-data 902 associated with each web page 110. The search engine 714 may match search terms 106 against the meta-data 902 when processing a query. Normally, the meta-data 902 is specified by the owner of the web page 110. For example, the owner of “Website23” may initially specify the following key words by which its web page 110 may be indexed: internet, security, antivirus, software, computer protection. Accordingly, a query including one or more of these key words may potentially result in the web page 110 being displayed.

However, a verified user 104 may notice that “Website23” is also an excellent resource for the removal of Trojan horses. Accordingly, the user may input the words “trojan removal” into the key words (meta-data) entry field of FIG. 6. This feedback is communicated through the network 706 to the index modification module 730, which updates the web page index 716 to include “trojan removal” in the meta-data for “Website23.” Consequently, a user 104 may locate “Website23” in a subsequent search using the search terms “trojan removal.”

While specific embodiments and applications of various methods and systems for conducting experiments over the Internet have been illustrated and described, it is to be understood that the disclosure claimed hereinafter is not limited to the precise configuration and components disclosed. Various modifications, changes, and variations apparent to those of skill in the art may be made in the arrangement, operation, and details of the methods and systems disclosed.

Furthermore, the methods disclosed herein comprise one or more steps or actions for performing the described method. The method steps and/or actions may be interchanged with one another. In other words, unless a specific order of steps or actions is required for proper operation of the embodiment, the order, and/or use of specific steps, and/or actions may be modified without departing from the scope of the disclosure as claimed.

The embodiments disclosed may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments of the present disclosure may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

What is claimed is:

1. A method comprising:
providing for receiving a query from a verified user;
providing for identifying one or more indexed web pages that match the query;
providing for listing at least a subset of the matching web pages in a random order; and
providing for displaying community feedback for at least one of the listed web pages based on individual feedback provided by one or more previous users who have viewed the at least one listed web page.

2. The method of claim 1, wherein the community feedback includes a community rating derived from individual ratings provided by the one or more previous users.

3. The method of claim 2, wherein the community rating includes at least one of the following ratings: poor, average, good, excellent, virus, spyware, and adware.

4. The method of claim 3, further comprising:
providing for flagging a particular web page for removal from the indexed web pages in response to the particular web page having a community rating of one of virus, spyware, and adware.

5. The method of claim 3, further comprising:
providing for notifying a system operator in response to a particular web page receiving an individual rating of virus, spyware, or adware.

6. The method of claim 1, wherein the community feedback includes a composite score derived from individual scores provided by the one or more previous users.

7. The method of claim 1, wherein the community feedback includes at least one comment provided by the one or more previous users.

8. The method of claim 7, wherein the community feedback includes the most recently provided comment.

9. The method of claim 7, wherein the community feedback includes a random one of a plurality of comments provided by the one or more previous users.

10. The method of claim 7, wherein providing for displaying community feedback comprises providing for displaying a link to the at least one comment.

11. The method of claim 1, further comprising:
providing for displaying a selected one of the listed web pages; and
providing for allowing the verified user to provide feedback on the selected web page.

12. The method of claim 2, further comprising:
providing for integrating the feedback provided by the verified user into community feedback for the selected webpage.

13. The method of claim 1, wherein providing for integrating comprises providing for using the feedback from the verified user to modify indexing for the selected webpage.

14. The method of claim 13, wherein using feedback comprises adding meta-data to an index for locating the selected webpage.

15. The method of claim 11, further comprising:
providing for rewarding users who provide feedback on a web page where no community feedback is currently available or the community feedback is stale.

16. The method of claim 15, wherein providing for rewarding comprises providing for entering each user providing feedback in a drawing.

17. The method of claim 15, wherein rewarding comprises awarding points to the users providing feedback, the points being usable for purchasing goods or services.

18. A method comprising:
locating one or more indexed web pages that match a query submitted by a verified user;
listing the one or more matching web pages in a random order;
allowing the verified user to provide individual feedback for a selected one of the listed web pages; and
in response to a subsequent query that results in the selected web page being listed, showing community feedback for the selected web page based at least in part on the individual feedback.

19. The method of claim 18, wherein the community feedback includes a community rating.

20. The method of claim 18, wherein the community feedback includes a comment provided by the verified user.

21. The method of claim 18, further comprising:
modifying the way in which the selected webpage is indexed based at least in part on the individual feedback provided by the verified user.

22. The method of claim 21, wherein modifying comprises adding meta-data to an index for locating the selected webpage.

23. The method of claim 18, wherein allowing the verified user to provide individual feedback comprises displaying the selected web page in a first window and a feedback mechanism for receiving the individual feedback in a second window.

24. The method of claim 23, wherein the feedback mechanism allows the verified user to select from a rating including at least one of the following ratings: poor, average, good, excellent, virus, spyware, and adware.

25. The method of claim 23, wherein the feedback mechanism allows the user to input a comment.

26. The method of claim 18, wherein allowing the verified user to provide individual feedback comprises displaying the selected web page and a feedback mechanism in different frames of the same window.

27. A method comprising:
randomly listing at least a subset of web pages matching a query submitted by a verified user;
allowing the verified user to provide individual feedback for a selected one of the listed web pages; and
modifying the way in which the selected webpage is indexed for subsequent searching based at least in part on the individual feedback provided by the verified user.

28. The method of claim 27, wherein modifying comprises adding meta-data to an index for locating the selected webpage.

29. The method of claim 27, wherein the individual feedback includes a rating.

30. The method of claim 27, wherein the individual feedback includes a comment.

31. The method of claim 27, further comprising:
compiling community feedback for the selected web page derived from the individual feedback provided by a plurality of verified users.

32. The method of claim 31, further comprising:
showing community feedback for at least one web page in connection with a random listing of matching web pages.

33. A user interface comprising:
a query area for receiving a query from a verified user;
a search results area for displaying a random listing of one or more indexed web pages that match the query; and
a community feedback area for displaying community feedback for at least one of the listed web pages based on individual feedback provided by one or more previous users.

34. The user interface of claim 33, further comprising:
a plurality of community feedback areas, one community feedback area being provided for each listed web page.

35. The user interface of claim 33, wherein the community feedback includes a community rating derived from individual ratings provided by the one or more previous users.

36. The user interface of claim 33, wherein the community rating includes at least one of the following ratings: poor, average, good, excellent, virus, spyware, and adware.

37. The user interface of claim 33, wherein the community feedback includes at least one comment, or a link to at least one comment, provided by the one or more previous users.

38. The user interface of claim 33, further comprising:
an individual feedback area to allow the verified user to provide individual feedback for a selected one of the listed web pages.

39. The user interface of claim 38, further comprising:
a selected web page area to display the selected web page.

40. The user interface of claim 39, wherein the selected webpage area is in a window separate from the individual feedback area.

41. The user interface of claim 39, wherein the selected webpage area is in a separate frame of the same window used for the individual feedback area.

42. The user interface of claim 38, wherein the individual feedback area includes a mechanism for selecting an individual rating for the selected web page.

43. The user interface of claim 38, wherein the individual feedback area includes a text field for inputting a comment.

44. A system comprising:
a web server to receive a query from a verified user, and to submit the query to a search engine for identification of one or more indexed web pages that match the query; and
a search results formatter to list at least a subset of the matching web pages in a random order and to display community feedback for at least one of the listed web pages based on individual feedback provided by one or more previous users.

45. The system of claim 44, wherein the community feedback includes a community rating derived from individual ratings provided by the one or more previous users.

46. The system of claim 45, wherein the community rating includes at least one of the following ratings: poor, average, good, excellent, virus, spyware, and adware.

47. The system of claim 46, further comprising:
a malicious activity monitor to flag a particular web page for removal from the indexed web pages in response to the particular web page having a community rating of virus, spyware, or adware.

48. The system of claim 46, further comprising:
a malicious activity monitor to notify a system operator in response to a particular web page receiving an individual rating of virus, spyware, or adware.

49. The system of claim 44, wherein the community feedback includes a composite score derived from individual scores provided by the one or more previous users.

50. The system of claim 44, wherein the community feedback includes at least one comment, or a link to at least one comment, provided by the one or more previous users.

51. The system of claim 44, further comprising:
an individual feedback module to allow the verified user to provide feedback on a selected one of the one or more web pages.

52. The system of claim 51, further comprising:
a feedback integration module to integrate the feedback provided by the verified user into community feedback for the selected webpage.

53. The system of claim 51, further comprising:
an index modification module to use the feedback from the verified user to modify an index used to locate the selected webpage.

54. The system of claim 53, wherein using the index modification module is to add meta-data to the index based on the feedback.

55. The system of claim 44, further comprising:
an incentive module to reward users who provide feedback on a web page for which no community feedback is currently available or the community feedback is stale.

56. The system of claim 55, wherein the incentive module is to enter each user providing feedback into a drawing.

57. The system of claim 55, wherein the incentive module is to award points to the users providing feedback, the points being usable for purchasing goods or services.

58. A machine-readable medium including program code that causes a machine to perform the operations of:
receiving a query from a verified user;
identifying one or more indexed web pages that match the query;
listing at least a subset of the matching web pages in a random order; and
displaying community feedback for at least one of the listed web pages based on individual feedback provided by one or more previous users who have viewed the at least one listed web page.

59. A computer data signal embodied in a transmission medium, comprising;
a code segment including instructions for receiving a query from a verified user;
a code segment including instructions for identifying one or more indexed web pages that match the query;
a code segment including instructions for listing at least a subset of the matching web pages in a random order; and
a code segment including instructions for displaying community feedback for at least one of the listed web pages based on individual feedback provided by one or more previous users who have viewed the at least one listed web page.
